(19) United States
(12) Patent Application Publication
(10) Pub. No.: US 2008/0196333 A1
(43) Pub. Date: Aug. 21, 2008

(54) Hurricane clip

(76) Inventor: Robert F. Tyler, Texas City, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/708,258

(22) Filed: Feb. 20, 2007

(51) Int. Cl. E06B 3/964

(52) U.S. Cl. 52/204.63

(57) ABSTRACT

An F-shaped panel fastener for securing a panel within a window opening comprises a bracket having first and second parallel flanges extending perpendicularly from a base plate member. The first and second flanges are spaced apart to receive the thickness of the panel edge to be secured between them by a screw inserted through the first flange. Several fasteners are installed around the perimeter of the panel. The panel is installed within an exterior window frame using screws passed through the base plate of each fastener to contact the window frame surface.

### BACKGROUND OF THE INVENTION

1. Field of the Invention

The present invention generally relates to fastening devices, and more particularly to a device for securing a panel within a window opening in a wall of a building vulnerable to storm damage to protect the window from flying debris.

2. Description of the Prior Art

Residents of regions of the country subject to severe but slow-moving storms such as hurricanes and the like generally have sufficient but limited time to install protective panels or other devices over the windows to protect the glass in them from flying debris. A number of panels and fastening devices have been devised or proposed to facilitate the rapid installation of protective panels in window openings. For example, U.S. Pat. No. 5,430,981 issued to Scott discloses a “Device for Installing Decorative Panels in Front of Existing Window Panes.” The disclosed transparent clip is secured to a window opening in a permanent manner that precludes easy removal and reuse of the decorative panels, and the clips do not appear to be readily adaptable to different thicknesses of panels or to uneven surfaces of a window opening.

In another example, U.S. Pat. No. 6,219,978 issued to Wood discloses a “Device for Covering Windows and Doors During Severe Storms” that relies on relatively complex and expensive “slide-arm-and-bolt assemblies” installed along a first edge of a panel and a resilient gasket installed along the opposite, second edge of the panel. The gasket holds the second edge against the window frame and the sliding bolt is adjusted outward to secure the first edge against the window frame. Wood's device permits reuse and rapid installation but is relatively complex and expensive, particularly for houses having numerous windows. In his U.S. Pat. No. 6,334,282, Wood also discloses a similar device that employs a pivoting lever with a foot at an outer end of the lever. The lever pivots on a pin supported by a plate attached to the panel and a spring biases the lever to engage the foot against the window frame when the spring end is released from a retracted position. This device and method exhibits the same disadvantages as in the '978 patent.

U.S. Pat. No. 6,363,670 issued to Dewitt discloses a device having a spring-loaded pin supported on a bracket, which is installed at intervals around a panel to be installed in the window opening after holes corresponding to the pin locations are drilled into the window frame surrounding the panel position. This device requires that the holes and pin/bracket positions be accurately aligned, and thus, while reusable, is relatively difficult to install. Rodrigues, in U.S. Pat. No. 6,330,768 discloses a cross brace device that extends from one side of the window frame to the opposite side, securing a panel between the cross brace and the window. While reusable, it is heavy, complex, and relatively expensive.

Renfrow, in U.S. Pat. No. 6,393,777 discloses channel-shaped brackets that are permanently installed on the wall containing the window just above and below the window opening. The upper brackets open downwards and the lower brackets open upwards, so that a panel may be slid laterally into the brackets from one side of the window and secured with a set screw in each bracket. Reusable and inexpensive, but requires accurate installation of the brackets and the panel is not set into the window opening but placed over the opening. This requires larger, more expensive panel sizes, and the edges of the panel are more exposed to the wind and possible failure of the protection.

In U.S. Patent Application Publication No. 2006/0123717, Huminski discloses a metal “h”-shaped bracket having “J”-shaped slots punched in the vertical portion of the bracket for hanging a panel, the panel being gripped between the “legs” of the bracket, upon screws driven into the soffit above a window opening. It is reusable and uncomplicated, but is installed over the window opening, not within it. The bracket appears to secure only the top edge of the panel above the window opening, leaving the other edges of the panel to be unsecured or, perhaps, secured by other means not disclosed.

Thus, there is a need for a fastening device for securing protective window panels within a window frame that is inexpensive to fabricate, install and reuse, permits rapid installation of the panels, can be adapted to different panel thicknesses and to various kinds of window openings without drilling holes into the window opening or permanently attaching the device to the area of or around the window opening.

### SUMMARY OF THE INVENTION

Accordingly there is disclosed a panel fastener for securing a panel within a window opening. The fastener resembles a block letter F in cross section and comprises an elongated base plate member (the vertical portion of the “F”) having at least one first hole through it at a first (i.e., the lower) end; and first and second spaced, parallel flanges integral with and extending perpendicularly from a first side of the base plate member. The flanges are placed respectively at a second (i.e., the top) end and a midpoint of the base plate member and spaced apart a distance slightly greater than the thickness of the panel to be secured between them.

The first flange extending from the second (top) end of the base plate member includes at least one hole through it to receive a second screw oriented toward the second flange to secure the edge of the panel between the first and second flanges. A second screw passed through the first hole in the base member and oriented in the opposite direction from the flanges is tightened against the side of the window opening when the panel (with several fasteners attached around the perimeter of the panel) is placed within the opening. The panel is thus secured within the window opening without drilling holes into the side of the window opening. These second screws at each fastener location provide an adjustability to variations in the window opening dimensions and to variations in the surface unevenness of the window openings.

The fastener is easy to fabricate from extruded aluminum strips. The holes punched or drilled in the base plate and the first (top) flange may be threaded by the screw when one is first inserted in the respective holes of the aluminum fastener. Panels using these fasteners may be easily installed and removed. The fasteners may also be used in panels of various thicknesses. Other sizes of fasteners—e.g., wherein the spacing between the flanges is varied—may be easily adapted to a wider range of panel thicknesses.

### BRIEF DESCRIPTION OF THE DRAWINGS

FIG. 1 illustrates a perspective view of one embodiment of a hurricane clip according to the present invention;

FIG. 2 illustrates the perspective view of FIG. 1 of one embodiment of a hurricane clip according to the present invention with hex head screws inserted into the threaded holes;

FIG. 3 illustrates a second perspective view of the embodiment of FIG. 1 in position as if it would be installed on the edge of a panel, the panel shown in phantom;

FIG. 4 illustrates one embodiment of a panel installed within a window opening using several of the hurricane clips as illustrated in FIGS. 1 and 2; and

FIG. 5 illustrates a detail view of one of the hurricane clips according to the present invention as installed on the edge of the panel shown in FIG. 4.

### DETAILED DESCRIPTION OF THE INVENTION

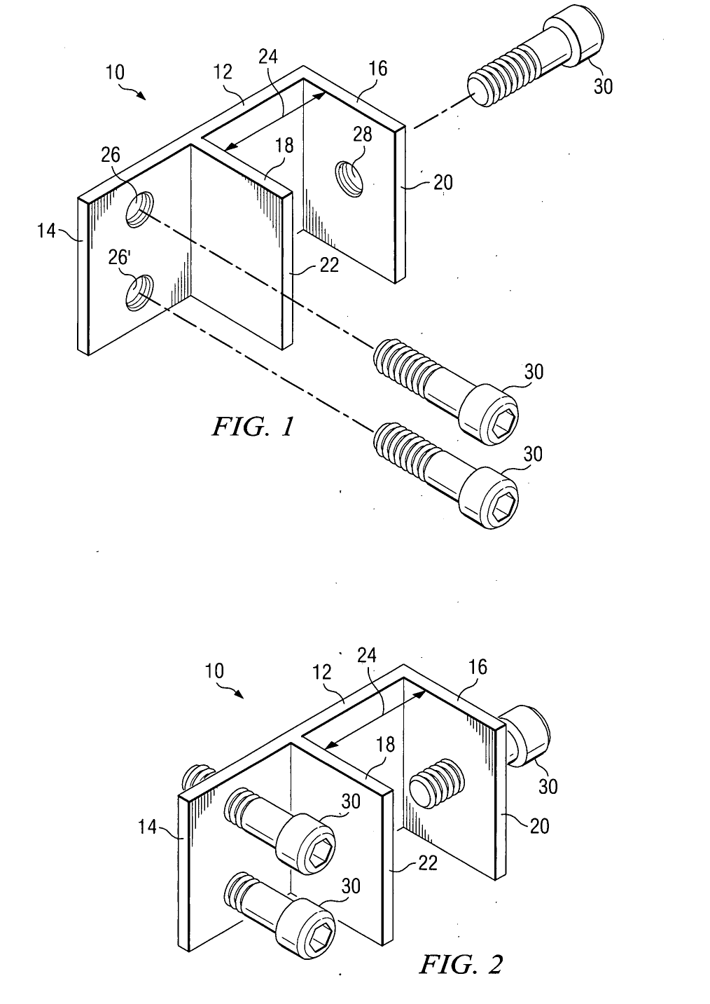

In the following description, the same reference numbers are used in the various figures to identify the same structures of the invention as illustrated. Referring to FIG. 1 there is illustrated a perspective view of one embodiment of a hurricane clip or panel fastener 10 according to the present invention. The panel fastener 10 is preferably a one piece component fabricated as a segment of an elongated extrusion of a suitable material such as aluminum. Segments—and panel fasteners 10—are formed by cutting the extrusion at equal intervals, e.g., at one inch intervals, thus forming one inch wide segments. Alternate materials may include but are limited to thermoplastic, composite materials, wood and other cellulosic materials. In FIG. 1 an elongated base plate 12 includes first and second ends 14, 16 and first and second flanges 20, 22 attached respectively to the base plate 12 at right angles. The base plate 12 further includes at least a first threaded hole 26 in the first end 14. A second threaded hole 26′ may be provided as shown. The threaded holes may be tapped to accept a 10-32 or other suitable machine screw as may be predetermined according to the particular application. The flanges 20, 22 are spaced apart a predetermined distance 24, typically at least one-half inch. In the illustrative example, for use with panels approximately three-fourths of an inch thick, the spacing would be slightly more than 0.750 inch and preferably approximately 0.813 inch to 1.00 inch.

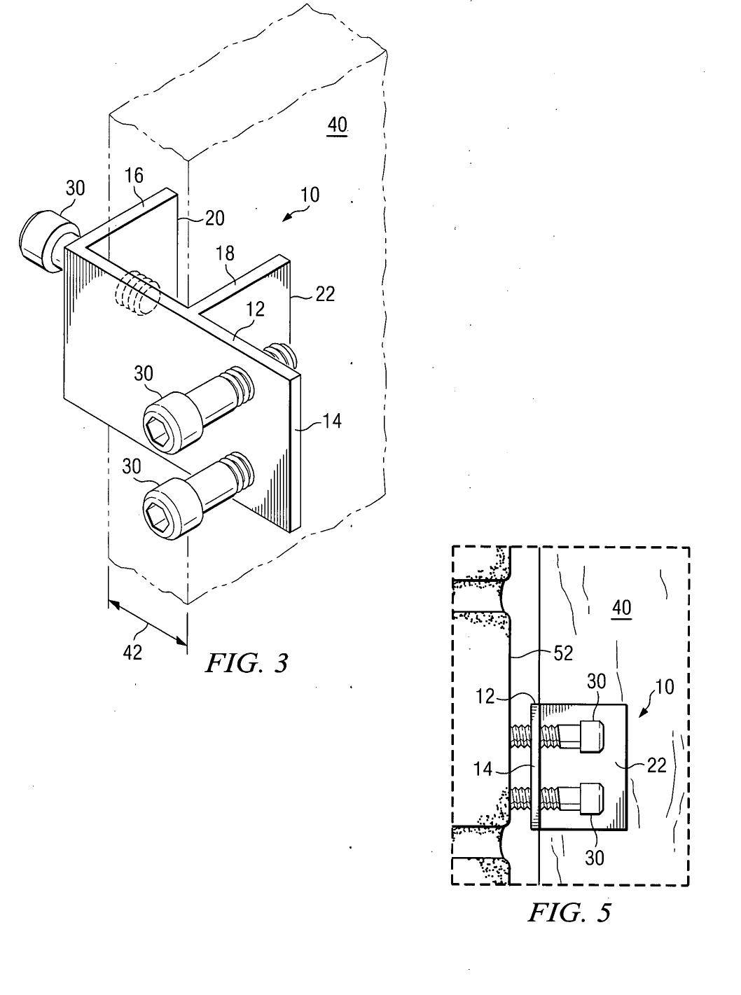

The first flange 20 includes a threaded hole 28 located at or near the center portion of the flange 20 and preferably an Allen or hex head socket screw 30 or Phillips head screw 30 threaded into the hole 28 for retaining the panel fastener 10 on the panel upon which it is installed as illustrated in FIG. 3 (to be described). The screws 30 for example may be approximately one inch long and have a size 10-32 thread or other suitable diameter and pitch. Hex head or Allen head machine screws 30 are preferred because of their socket-head feature, which resists tampering. However, other head styles such as slotted pan head or slotted or Phillips round head may be satisfactory and more readily available. The holes 26, 26′ and 28 may be separately tapped or tapped as the screws 30 are inserted for the first time when the screws 30 are fabricated of a harder material (e.g., steel) than the base plate 12 or flange 20 (e.g., aluminum).

In one typical example, the panel fastener 10 may be adapted from a type F750 aluminum corner manufactured by Brunner Enterprises, Inc., West Seneca, N.Y. 14224 or www.brunnerent.com. This corner material has a cross section that closely resembles a capital block letter “F” having its horizontal extensions or flanges separated by 0.755 inches for receiving panels (see, e.g., panel 40 in FIG. 3) that are nominally 0.750 inches thick between them. The addition of the threaded holes in the prescribed locations and the hex socket or Allen head screws 30 inserted therein enables the segments of the aluminum corner strips to be modified into the panel fastener 10.

Referring to FIG. 2 there is illustrated the perspective view of FIG. 1 of one embodiment of a hurricane clip or panel fastener 10 according to the present invention with hex head or Allen head screws 30 inserted into the threaded holes 26, 26′, and 28.

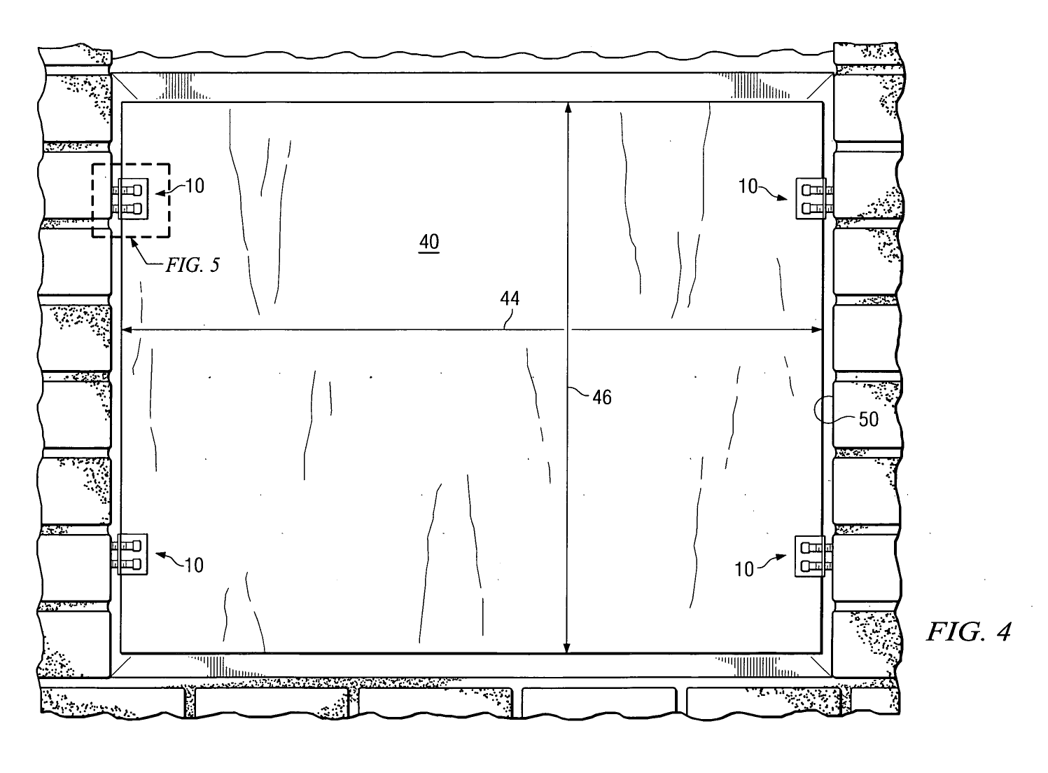

Referring to FIG. 3 there is illustrated a second perspective view of the embodiment of FIG. 1 in position as if it would be installed on the edge of a panel 40 having a thickness dimension 42, the panel 40 shown in phantom. For adequate protection against flying debris, the panel(s) supported by the panel fasteners disclosed herein should be cut from rigid panel material approximately 0.750 inches thick; however, panels of lesser thickness, e.g., one-half inch thick may be suitable, particularly for smaller windows, and have the advantage of lighter weight that may facilitate installation. Suitable materials include but are not limited to plywood, pressed board products, exterior wallboard, polycarbonate sheet, composite sheet, sheet metal, and the like. When thinner materials are used for the panel 40, the spacing between the flanges of the panel fastener 10 will need to be reduced proportionately. The screw 30 is provided in the first flange 20 to securely clamp the edge of the panel 40 between the flanges 20, 22 of the panel fastener 40 by turning the screw 30 toward the surface of the panel 40 (and toward the second flange) so that the panel is clamped between the end of the screw 30 and the surface of the second flange 22. In some applications it may be appropriate to insert a shim (not shown but readily understood by persons of skill in the art) between the screw 30 and the surface of the panel 40 to distribute the force of the tightened screw 30. After a suitable number of panel fasteners are secured to the edges of the panel 40, the panel is ready to be installed within the window, as will be described in conjunction with FIG. 4.

Referring to FIG. 4 there is illustrated one embodiment of a panel 40 installed within a window opening using several of the hurricane clips or panel fasteners 10 as illustrated in FIGS. 1 and 2. A panel 40 having a width 44 and a height 46 is shown placed within a window opening 50 of a building. The panel 40 is held in place within the window opening 50 by four panel fasteners 10 as shown by tightening the screws 30, which pass through the first end 14 of the base 12, against the corresponding sides 52 (see FIG. 5) of the window opening 50. The screws 30 permit adjusting the panel fastening to fit the dimensions 44, 46 of the window opening 50 and to adjust for uneven surfaces along the sides 52 of the window opening.

FIG. 4 illustrates a panel secured within a window opening using only four panel fasteners 10, which is an adequate number for small window openings. In other installations, more panel fasteners 10 would be required to provide sufficient support for a larger, heavier panel. For removal, the screws may be loosened slightly and the panel 40 lifted away from the opening 50. The panel fasteners 10 may be left on the panel 40 for reinstallation or removed for reuse on a different panel.

Referring to FIG. 5 there is illustrated a detail view of one of the hurricane clips or panel fasteners 10 according to the present invention as installed on the edge of the panel 40 shown in FIG. 4. The screws 30 permit adjustments for the dimensions 44, 46 of the window opening 50 and for uneven surfaces on the face of the sides 52 of the window opening 50. In some cases it may be necessary to move the panel fastener 10 along the edge of the panel 40 to improve the fit of the panel 40 within the opening 50.

In use, the panel fasteners 10 and panels 40 described herein may be used to secure panels 40 within window or door openings 50 for any purpose, not just security from flying debris. A principle feature of the panel fasteners 10 is that they permit relatively quick, temporary mounting of protective panels within the openings of buildings at minimum cost for materials and labor. Further, the panel fasteners are reusable and adjustable to variations in the dimensions of openings to be covered.

While the invention has been shown in only one of its forms, it is not thus limited to the specific embodiment illustrated and described herein but is susceptible to various changes and modifications without departing from the spirit thereof and falling within the scope of the appended claims setting forth the invention. It will be appreciated that the novel configuration of the panel fasteners herein described permits a wide variety of applications to be satisfied. The panels 40 may be made of nearly any rigid sheet material. If it is necessary to protect the surface of the panel 40 from damage by the point end of the screws 30 as they are tightened against the panel 40, small, shim-like pads (not shown) may be used between the point end of the screw 30 and the surface of the panel 40.

Further, as is well known to persons skilled in the art, machine and other types of screws are available having a variety of point end configurations such as an oval point or a hollow flat point, for example. Similarly, the panel fastener 10 or hurricane clip of the present invention may be secured using a wide variety of machine screws 30. Other materials may be used to fabricate the panel fasteners 10 or hurricane clips, such as other metals, thermoplastic or composite materials, wood or other cellulosic materials, as long as the panel fastener base-and-flange units may be fabricated at reasonable cost in volume. Processes suitable for such fabrication include injection molding, extrusion, and the like.

What is claimed is:

1. A panel fastener for securing a panel within a window opening, comprising:
an elongated base plate member having at least first and second threaded holes there through at a first end;
first and second parallel, spaced flanges integral with and extending perpendicularly from the base plate member respectively at a second end and a midpoint thereof;
wherein the first flange extending from the second end of the base plate member includes at least one hole there through for threading a first screw oriented toward the second flange to secure an edge of the panel between the flanges; and
wherein second and third screws threaded respectively into the first and second threaded holes through the base member are oriented opposite the direction of extension of the first and second flanges.

2. The panel fastener of claim 1, wherein the spaced flanges are spaced apart a distance greater than the thickness of the panel to be secured there between.

3. The panel fastener of claim 2, wherein the distance the first and second flanges are spaced apart is at least one-half inch.

4. The panel fastener of claim 1, wherein the panel fastener is fabricated from an aluminum extrusion having a cross section shaped like a block letter F.

5. The panel fastener of claim 4, wherein each hole in the panel fastener is threaded upon a first insertion of a screw therein.

6. The panel fastener of claim 1, formed as a segment of an extrusion of a rigid material selected from the group consisting of:
metal, thermoplastic, composite materials, wood, and other cellulosic materials.

7. The panel fastener of claim 1, wherein the first, second, and third screws are threaded partially through each first and second hole at the first end of the base plate member.

8. The panel fastener of claim 1, wherein the first, second, and third screws are selected from the group consisting of pan head, Allen head, and round head.

9. A combination, comprising:
a rectangular panel of rigid sheet material cut to the dimensions of a window opening less a predetermined margin around the perimeter of the panel; and
a plurality of the panel fastener of claim 1 installed at predetermined intervals around the perimeter of the rectangular panel.

10. The combination of claim 9, wherein the rectangular panel is fabricated of materials selected from the group consisting of wood, pressed wood products, wallboard, plastic, metal, and composite materials.

12. The combination of claim 9, wherein the predetermined margin is less than one inch.

13. The combination of claim 9, further comprising a shim placed between the point end of the first screw and the panel.

14. A panel fastener for securing a panel within a window opening, comprising:
an elongated base plate member having at least one hole there through at a first end;
first and second flanges integral with and extending perpendicularly from a first side of the base plate member respectively at a second end and a midpoint thereof;
wherein the first and second flanges are parallel and spaced apart a distance greater than the thickness of the panel to be secured there between; and
wherein the first flange extending from the second end of the base plate member includes at least one hole therethrough.

15. The panel fastener of claim 14, wherein the elongated base plate member includes first and second holes there through at the first end.

16. The panel fastener of claim 15, wherein each first and second hole in the base plate member is tapped with a predetermined screw thread.

17. The panel fastener of claim 16, further comprising first and second screws threaded partially through each first and second hole at the first end of the base plate member.

18. The panel fastener of claim 17, wherein the first and second screws are selected from the group consisting of pan head, Allen head, and round head.

19. The panel fastener of claim 14, wherein the distance the first and second flanges are spaced apart is at least one-half inch.

20. The panel fastener of claim 14, formed as a segment of an extrusion of a rigid material selected from the group consisting of:
metal, thermoplastic, composite materials, wood, and other cellulosic materials.

21. The panel fastener of claim 14, wherein the fastener is fabricated from an aluminum extrusion having a cross section shaped like a block letter F.

22. The panel fastener of claim 21, wherein each hole is threaded upon a first insertion of a screw therein.

23. A combination, comprising:
a rectangular panel of rigid sheet material cut to the dimensions of a window opening less a predetermined margin around the perimeter of the panel; and
a plurality of the fastener of claim 17 installed at predetermined intervals around the perimeter of the rectangular panel.

24. The combination of claim 23, wherein the predetermined margin is less than one inch.

25. The combination of claim 23, wherein the rectangular panel is fabricated of materials selected from the group consisting of wood, pressed wood products, wallboard, plastic, metal, and composite materials.

26. The combination of claim 23, further comprising a shim placed between the point end of the screw and the panel.
